(19) United States
(12) Patent Application Publication
(10) Pub. No.: US 2016/0267616 A1
(43) Pub. Date: Sep. 15, 2016

(54) Course Skill Matching System and Method Thereof

(71) Applicant: Kaplan, Inc., New York, NY (US)

(72) Inventors: Peter Smith, Ft. Lauderdale, FL (US); Damien Cooper, Ft. Lauderdale, FL (US)

(21) Appl. No.: 15/069,931

(22) Filed: Mar. 14, 2016

Related U.S. Application Data
(60) Provisional application No. 62/132,361, filed on Mar. 12, 2015.

(51) Int. Cl. G06Q 50/20; G06Q 10/10; G06F 17/30; G06Q 50/00

(52) U.S. Cl. CPC G06Q 50/2057; G06Q 50/01; G06Q 10/1053; G06F 17/30867; G06F 17/30707; G06F 17/30654

(57) ABSTRACT

A system, method, and computer-readable medium having instructions thereon, are provided for analyzing existing skills of a candidate, position requirements in various career fields, and determining gaps between the candidate's skill set and the position requirements. For example, position requirements can include a number of years of experience, certifications required, previous positions held, knowledge of a system and/or program, and accomplishing certain tasks. For example, information on positions can be mined from j ob postings on websites on the Internet, company listings, and through social media. The system, method, and computer-readable medium can be used via a computer terminal, a hand held processor, and a mobile device, among other devices.

### CROSS-REFERENCE TO RELATED APPLICATIONS

The present invention claims priority to U.S. Provisional Patent Application Ser. No. 62/132,361, filed on Ma. 12, 2015, entitled “Course Skill Matching System and Method Thereof,” the entirety of which is incorporated herein by reference.

### FIELD OF INVENTION

The present invention relates to a system, method, and computer-readable medium having instructions thereon for a matching-skills software.

### RELATED INFORMATION

Postings for jobs in today's workplace often list multiple requirements and necessary skills for a position. People desiring to enter into a career must have those skills to be a successful candidate for the desired position.

### BRIEF DESCRIPTION OF THE DRAWINGS

FIG. 1A shows an embodiment of the present invention.

FIG. 1B shows an embodiment of the present invention.

FIG. 2A shows an embodiment of the present invention.

FIG. 2B shows an embodiment of the present invention.

FIG. 3 shows an embodiment of the present invention.

FIG. 4 shows an embodiment of the present invention.

FIG. 5 shows an embodiment of the present invention.

FIG. 6 shows an embodiment of the present invention.

FIG. 7 shows an embodiment of the present invention.

FIG. 8 shows an embodiment of the present invention.

### DETAILED DESCRIPTION

An embodiment of the invention is a system and method for analyzing existing skills of a candidate, position requirements in various career fields, and determining gaps between the candidate's skill set and the position requirements. Position requirements can include a number of years experience, certifications required, previous positions held, knowledge of a system and/or program, and accomplishing certain tasks. For example, information on positions can be mined from job postings on websites on the Internet, company listings, and through social media. Information on job position requirements can be provided directly to the system. Websites having job postings from multiple companies and across many industry and position areas include, for example, Indeed®, Monster.com, and CareerBuilder®. Social media includes Facebook, LinkedIn®, and Twitter. Certifications required can include, for example, licenses granted by state and/or federal agencies, and/or certifications provided by private corporations. Knowledge of certain systems and/or programs can include computer programming including but not limited to C++, Java, Ruby, and/or Perl, computer aided design and computer aided manufacturing (CAD/CAM) programs including but not limited to AutoCAD, Solidworks, Unigraphics, and/or Pro/Engineer, and enterprise resource planning programs including but not limited to SAP.

For example, job postings can be data mined real-time, from publicly available resources. As opposed to government-provided statistical data on jobs and skills related to the jobs, relying on real-time job posting data can provide a more accurate landscape of the workforce and the requirements for a successful candidate. As information is added to and updated in the model, the system can adapt and learn to achieve more accurate information. Information provided can include, for example, candidates' resumes, transcripts, and certifications. Information provided can include job descriptions and career requirements. Information provided can include course descriptions and course credit information. For example, as more information is provided about candidates' backgrounds, skill sets, and career information, the system provides improved information as to the courses necessary to match a candidate to a desired career position. For example, the system can include a master algorithm that, when updated and/or changed in any aspect, the entire system responds to the change.

In an embodiment of the invention, a gap analysis can be completed. The system can determine what educational or course programs are necessary to obtain the skills for the desired career field. For example, the system can review a candidate profile including resume, coursework, transcripts, certifications and/or other work-related information. The system can match up job requirements to the candidate profile. The system can determine one or more elements the candidate has and compare to the elements of the job profile. The candidate can review which personal elements match a job profile and which elements are missing.

An embodiment of the present invention describes that potential candidates can be informed about what coursework is necessary to pursue a desired career, and can be provided with a roadmap on how to attain the necessary skills. An embodiment of the invention includes reviewing coursework completed at an institution, and reviewing coursework completed at another institution. The institution can be a school, preparatory school, high school, college, university, trade school, and/or institute. Coursework can include courses, class names, class descriptions, hours per week in lectures, grades, exam scores, state exam scores, advanced placement (AP) test scores, laboratories, student teaching, externships, and/or internships. Coursework can also be determined if a course was taken for credit, pass/fail, or non-credit. Coursework at an institution can be compared to coursework at another institution to determine whether credit can be awarded when transferring between one institution and another institution. The coursework can be compared by comparing one or more elements of the coursework. When a certain amount of the elements of the coursework overlap between the institutions, the coursework can be determined to be transferable.

An embodiment of the present invention includes a student that may have received credit for taking a science class at a first college, but desires to receive credit for taking the science class at a second college, to avoid having to repeat classes unnecessarily. To determine whether the science class is transferable, the first science class can be compared to a second science class offered at the second college. The science classes can each contain certain elements, for example, a certain number of credits, a laboratory, a certain grade level, and/or exam score. If these elements between the first science class and the second science class have enough of the same elements, then the student would receive credit for the first science class taken, and not be required to take the second science class.

An embodiment of the present invention describes a deep learning model initially applying a large amount of information of job positions, course descriptions, and candidate resumes available from open sources, received from one or more websites and/or inputs as described above. Deep learning is learning from one or more algorithms to model data to form a hierarchical representation. The system can adapt as more information is received, and updated, and one or more algorithms allow for machine learning, or artificial intelligence of the system. A recurrent neural network can learn associations between words. For example, texts can be treated as sequences in time. For example, the system can determine patterns and relationships in words, and adapt and evolve as the information is mined and/or input.

An embodiment of the present invention describes that known words of skills can be used in word clusters to predict words in a surrounding context of the text. For example, the result is a network of words associated to a known network of skills. Words are clustered together that closely relate to each other, allowing the system to mine courses, resumes, and job positions. For example, associated words, or skills can be “leader,” “president,” and “chairman.”

The words can then be related to closely embedded words, which can provide skills related to a word. For example, “finance” can relate to “accounting,” “economics,” “taxation,” “autocash,” and “treasury.” Once a skill is identified, it can be connected to job postings requiring that skill. The identified skill can also be connected with courses teaching that skill. A candidate, having a skill set, and an identified skill gap, can be matched to one or more courses that satisfy a skill necessary related to a job.

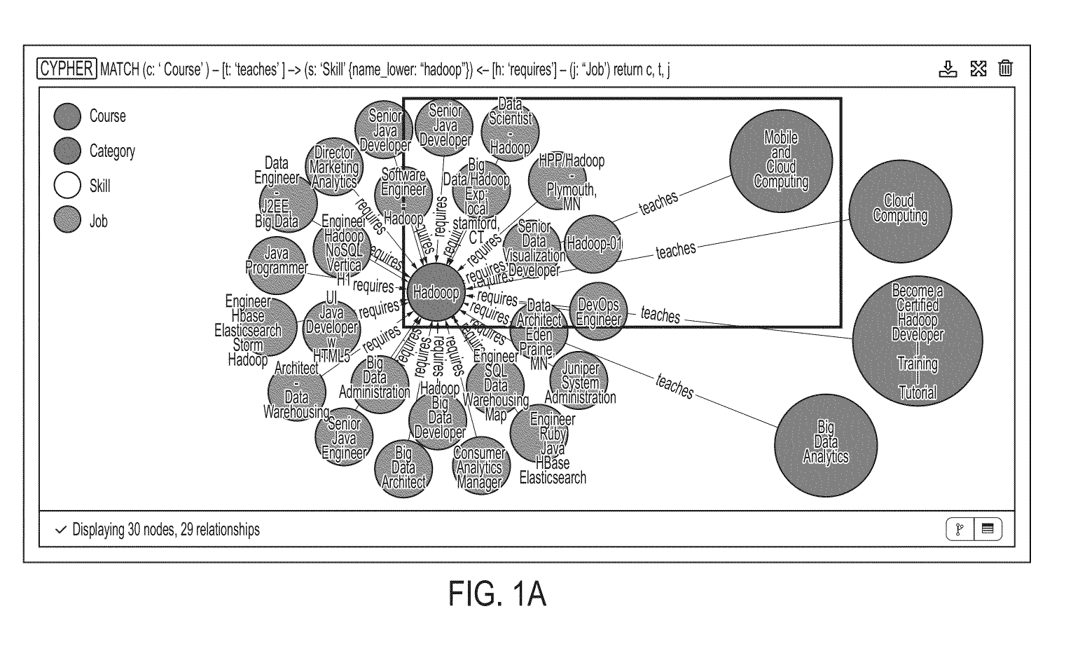

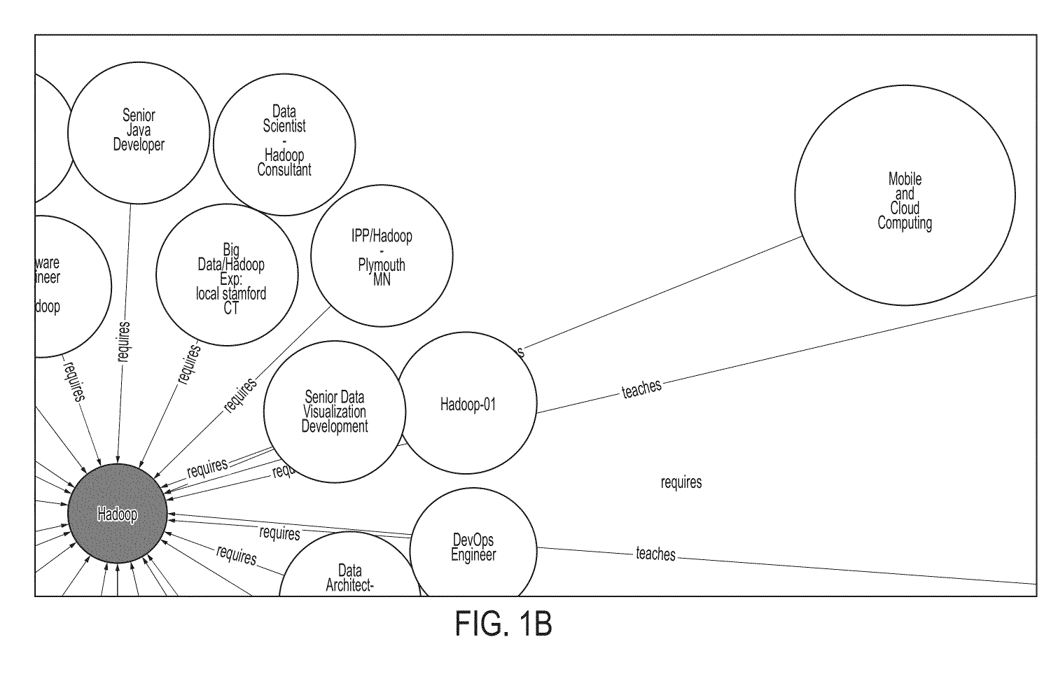

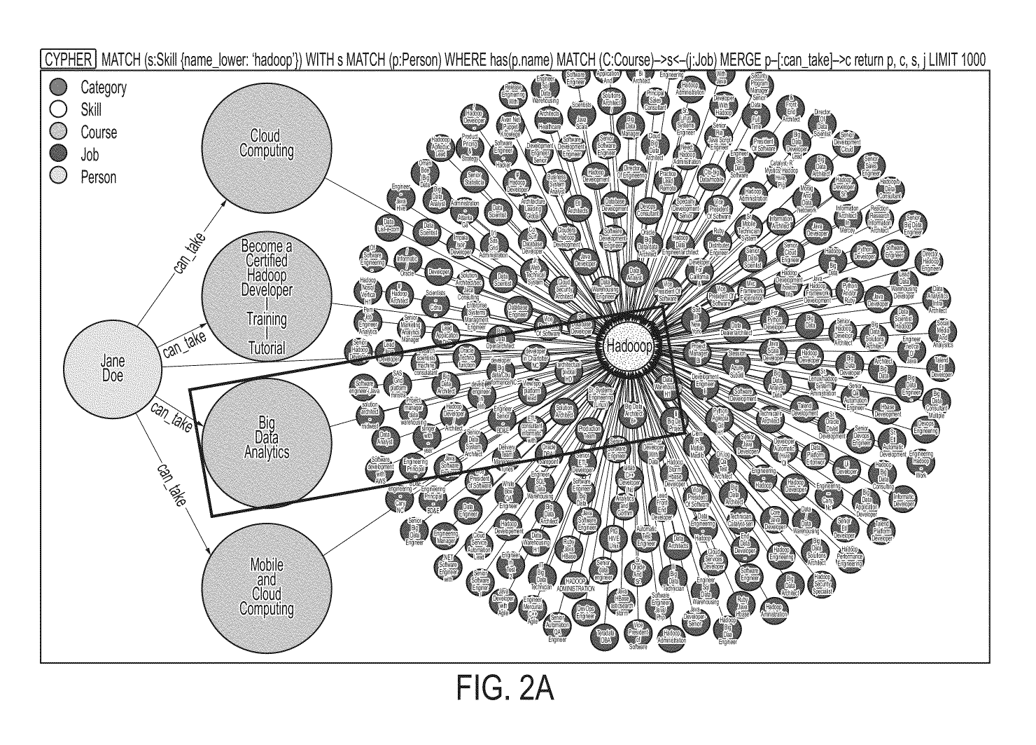

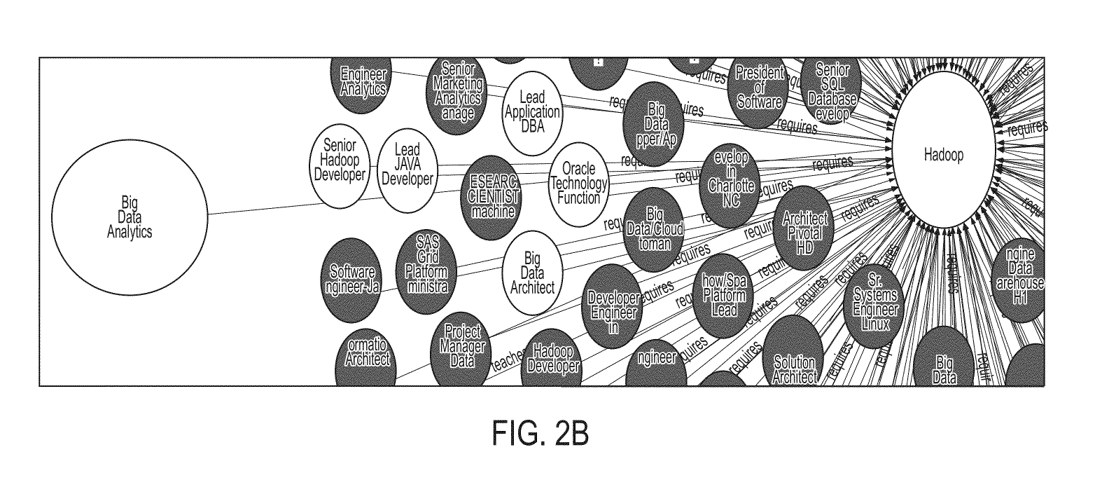

An embodiment of the present invention describes FIGS. 1A and 1B showing a software skill Apache “Hadoop” connected to a plurality of job positions that include it as a necessary skill. Hadoop is open-source software in which a candidate needs to understand for a job position. Hadoop is also connected to a plurality of courses available, such as through massive open online courses (“MOOC”) including but not limited to “mobile and cloud computing” and “big data analytics” courses. FIG. 1B is a close-up view of the rectangular area marked in FIG. 1A. FIGS. 2A and 2B show a candidate, Jane Doe, who, based on her provided resumes, transcripts, and certifications, does not have software Hadoop skills. Jane Doe is connected to taking one of these MOOCs to provide her with the necessary software Hadoop skills, which then provides her with the skills to be a candidate for a plurality of job positions, including but not limited to a “data scientist,” a “senior Java developer,” and a “senior Hadoop developer.” FIG. 2B is a close-up view of the rectangular area marked in FIG. 2A.

An embodiment of the present invention can include the word “manufacturing.” From manufacturing, words can be clustered including “lean manufacturing,” “Kaizen,” “six sigma,” and “black belt,” which relate to a known process to reduce waste in a workplace process. Lean manufacturing can be identified from a cluster including the word manufacturing. Knowledge of lean manufacturing can be required for manufacturing job positions. A candidate for manufacturing positions may lack lean manufacturing skills required for a desired position. The candidate can then be matched with one or more courses teaching lean manufacturing, which would then provide the candidate with the skill set of a desired position.

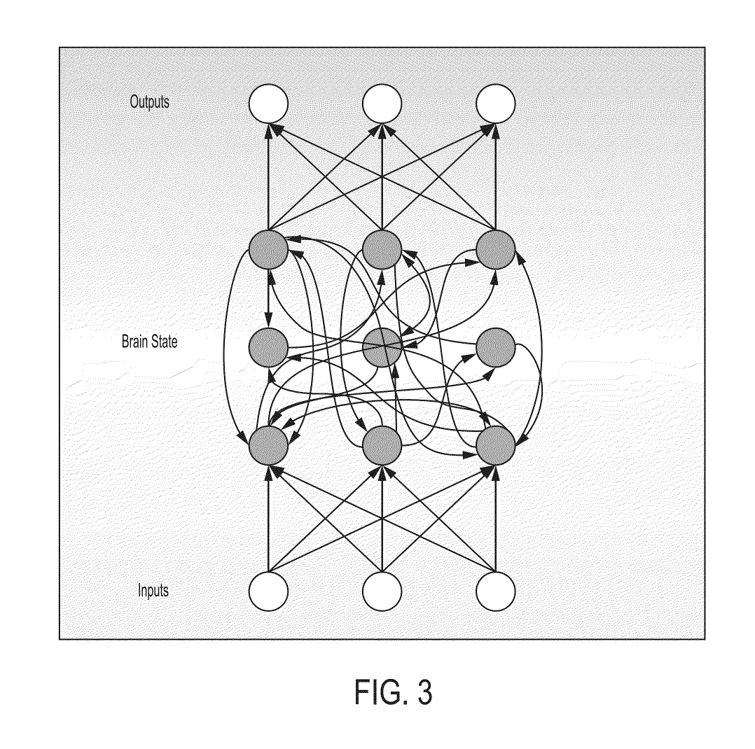

FIG. 3 shows an embodiment of the present invention in which a deep recurrent neural being used in embodiments as powerful sequence approximators. For example, the text is treated as sequences in time rather than just as words or series of characters. In an embodiment, this is applied to a network prepared by an embodiment of the present invention. The network can be of jobs, courses, resumes, and other information sources regarding job skills or course skills or attributes useful or desired for any of the foregoing. In an embodiment, this information is scraped from a network, a Kaplan network, or other sources including the internet, university websites, commercial databases and/or electronically accessible sites, and other sources.

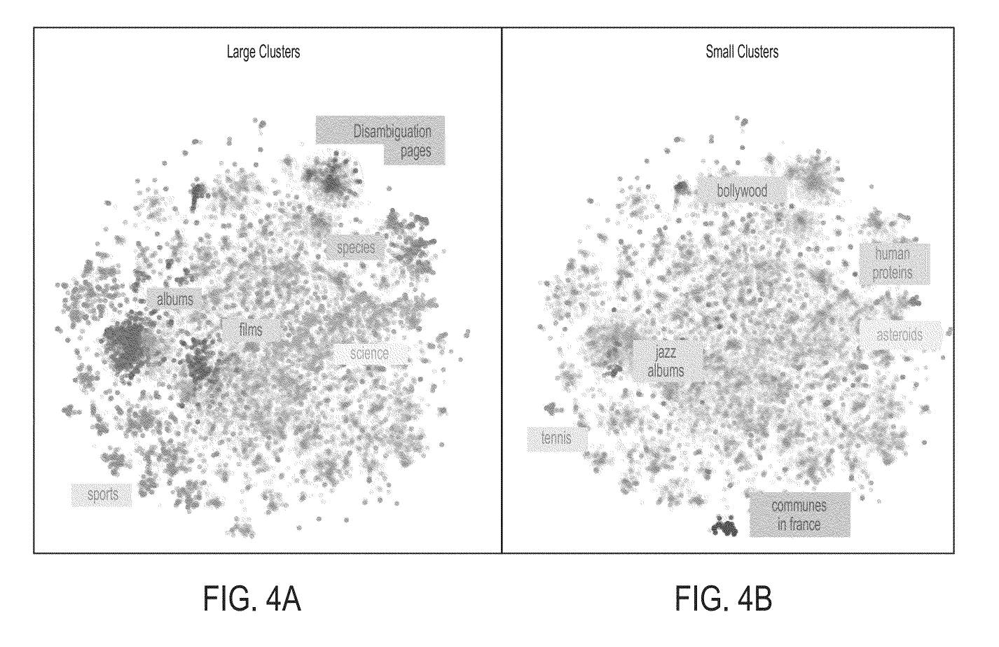

FIG. 4 shows a deep learning model example of an embodiment of the present invention. For example, a list of known skills is taken or scraped or otherwise obtained. The surrounding context of the text is the used to predict which other words would fit in its place given that same context. For example there can be clusters of words that appear in similar contexts using random words. In FIG. 4, an example is shown of clusters of words that appear in similar contexts using random words in Wikipedia. For example, in the large clusters of words, the words include disambiguation pages, species, films, albums, science, and sports. For example, in the small clusters of words, the words include bollywood, jazz albums, human proteins, asteroids, tennis, and communes in france.

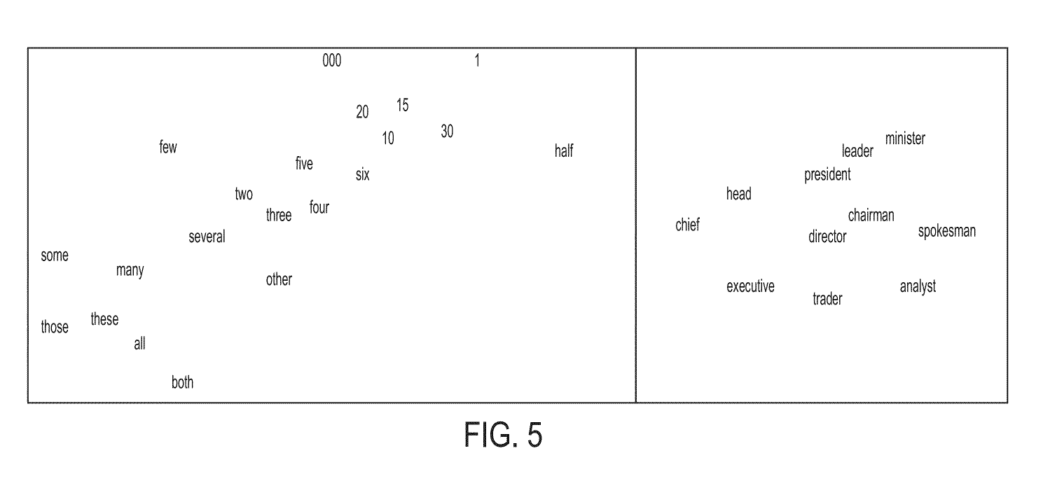

FIG. 5 shows an example of the deep learning model where the words of FIG. 4 or other example, provides a network of words that are similar to a known network of skills. For example, the system can mine educational or vocational courses, resumes, and jobs, using an embodiment of the present invention. Then, as shown in FIG. 5, an embodiment provides a scalable model that can learn contexts given any set of words. For example, a high level (tSNE) representation of words is shown that are closely related that are of interest. Then, as shown on the left of the diagram, more clusters are shown. Certain words naturally cluster together naturally.

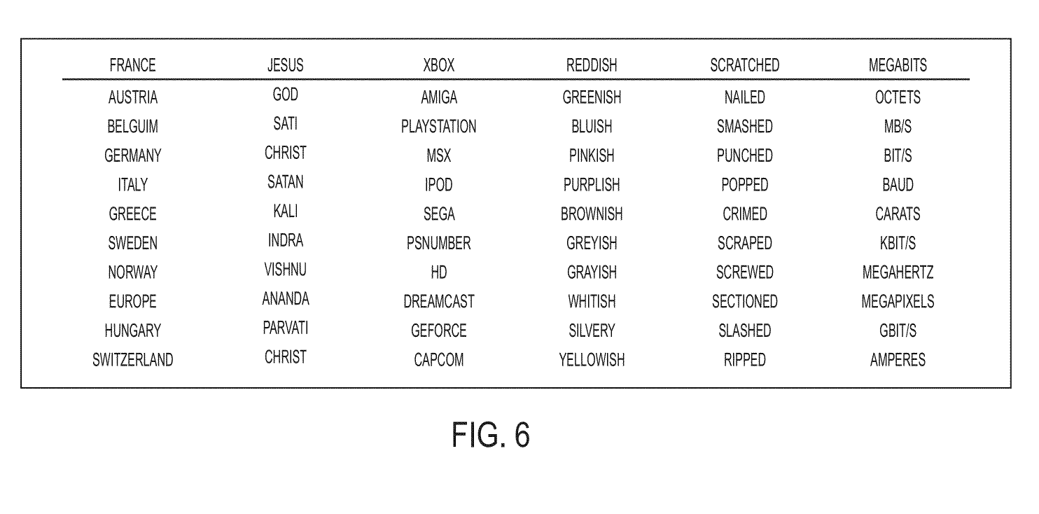

FIG. 6 shows an example deep learning model in which word embeddings can be skill embeddings. For example, shown are examples of relatively ordinary words and some closest embedded words. There is a similarity among the words. This can also be done for skill embedding examples. For example, such clusterings can be:

a) Finance: accounting, economics, taxation, autocash, treasury, . . .

b) Python: Bash, Perl, Ruby, Scripting, TCL, C#, C++, Groovy, Scala, Languages, . . .

c) UX: UI, designer, developers, graphic, wireframe, user . . .

d) Excel: Outlook, PowerPoint, Word, Visio, MS, PPT, MSWord, . . .

e) Analysis: analyses, modeling, econometric, statistical, correlation . . .

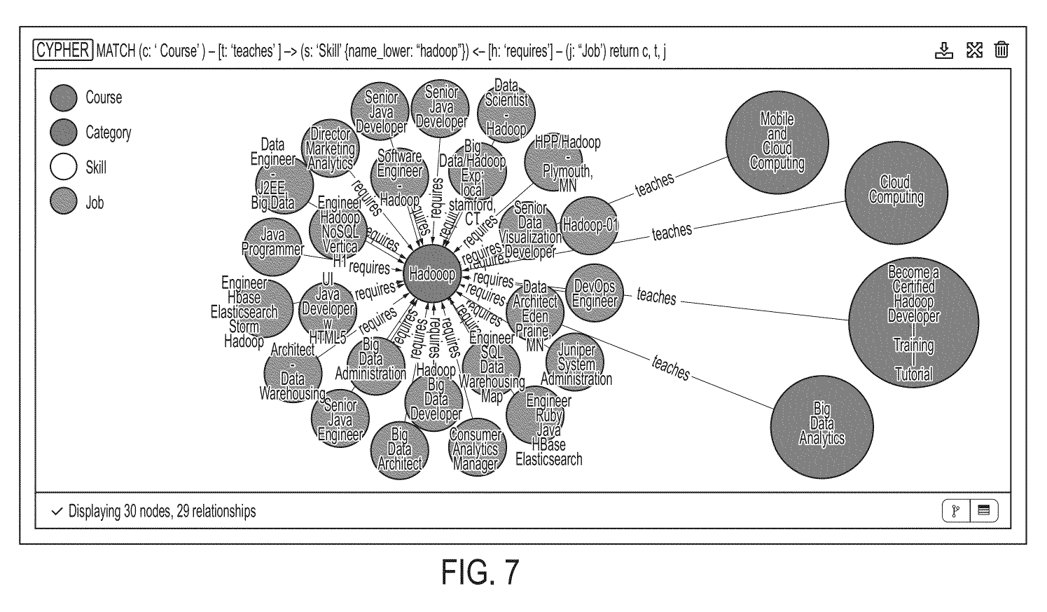

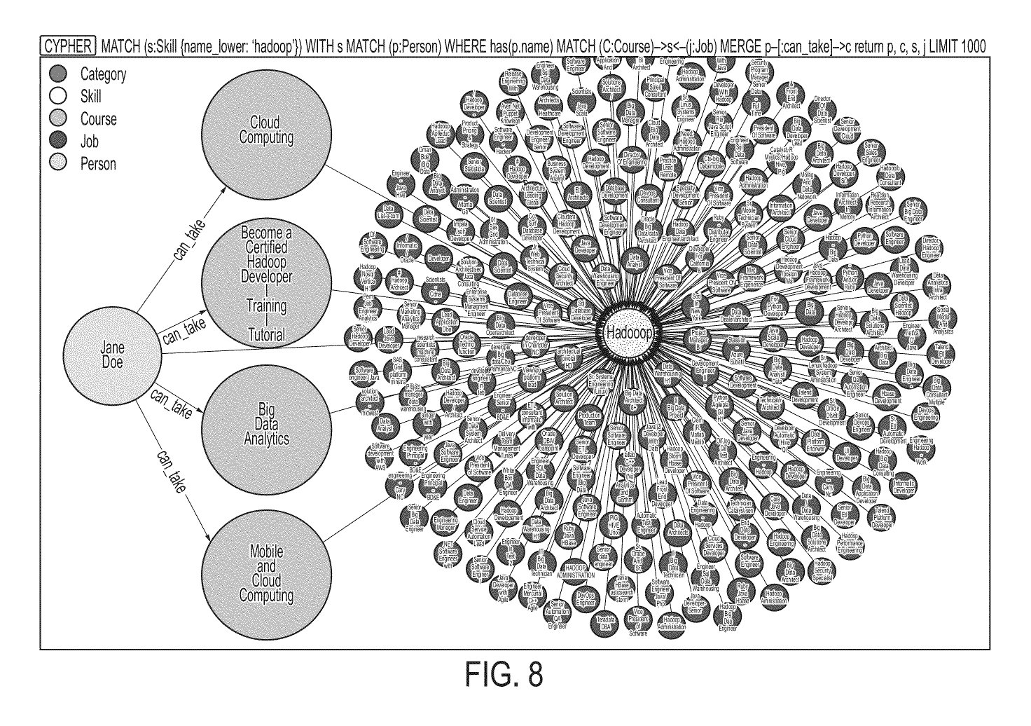

FIG. 7 shows an example deep learning model which demonstrates an example way to use the clustering. FIG. 8 shows another example deep learning model which demonstrates an example way to use the clustering.
It should be appreciated that the present invention can be implemented in numerous ways, including as a process, an apparatus, a system, a computer processor executing software instructions, or a computer readable medium such as a non-transitory computer readable storage medium, or a computer network wherein program instructions are sent over optical or electronic communication or non-transitory links. It should be noted that the order of the steps of disclosed processes can be altered within the scope of the invention, as noted in the appended claims and in the description herein.

The computer processor and algorithm for conducting aspects of the methods of the present invention may be housed in devices that include desktop computers, scientific instruments, hand-held devices, personal digital assistants, phones, a non-transitory computer readable medium, and the like. The methods need not be carried out on a single processor. For example, one or more steps may be conducted on a first processor, while other steps are conducted on a second processor. The processors may be located in the same physical space or may be located distantly. In some such embodiments, multiple processors are linked over an electronic communications network, such as the Internet. Preferred embodiments include processors associated with a display device for showing the results of the methods to a user or users, outputting results as a video image and the processors may be directly or indirectly associated with information databases. As used herein, the terms processor, central processing unit, and CPU are used interchangeably and refer to a device that is able to read a program from a computer memory, e.g., ROM or other computer memory, and perform a set of steps according to the program. The terms computer memory and computer memory device refer to any storage media readable by a computer processor. Examples of computer memory include, but are not limited to, RAM, ROM, computer chips, digital video discs, compact discs, hard disk drives and magnetic tape. Also, computer readable medium refers to any device or system for storing and providing information, e.g., data and instructions, to a computer processor, DVDs, CDs, hard disk drives, magnetic tape and servers for streaming media over networks.

Embodiments of the present invention provide for accessing data obtained via a user's smartphone, smart device, tablet, iPad®, iWatch®., or other device and transmit that information via a telecommunications, WiFi, or other network option to a location, or other device, processor, or computer which can capture or receive information and transmit that information to a location. In an embodiment, the device is a portable device with connectivity to a network or a device or a processor. Embodiments of the present invention provide for a computer software application (or “app”) or other method or device which operates on a device such as a portable device having connectivity to a communications system to interface with a user to obtain specific data, push or allow for a pull, of that specific data by a device such as a processor, server, or storage location. In embodiments, the server runs a computer software program to determine which data to use, and then transforms and/or interprets that data in a meaningful way.

Although the foregoing invention has been described in some detail for purposes of clarity of understanding, it will be apparent that certain changes and modifications can be practiced within the scope of the appended claims. The present invention can be practiced according to the claims and/or the embodiments without some or all of these specific details. Portions of the embodiments described herein can be used with or without each other and can be practiced in conjunction with a subset of all of the described embodiments. The various features of embodiments described can be used with and without each other, in various combinations. For the purpose of clarity, technical material that is known in the technical fields related to the invention has not been described in detail so that the present invention is not unnecessarily obscured. It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. A method for a course skills matching computer software program product, comprising:
obtaining at least one job skill from at least one job posting;
obtaining at least one course attribute from at least course posting;
storing the at least one job skill and the at least on course attribute in an electronic memory;
modeling the at least one job skill and the at least one course attribute in the form of at least one hierarchical representation;
applying a recurrent neural network algorithm which determines at least one of a pattern and a relationship between words of the at least one job skill and the at least one course attribute stored, in order to develop a network of the words associated with a network of job skills and a network of course attributes;
wherein the network of words is used to determine a matching between the network of job skills and the network of course attributes so that a correlation between at least one job skill and at least one course attribute is made.

2. The method of claim 2, further comprising:
updating the at least one hierarchical representation as additional job skills and additional course skills are obtained.

3. The method of claim 2, wherein the modeling is adaptive.

4. A system, comprising:
a device for obtaining information from at least one website;
a neural network system for determining the clustering between words of the obtained information; and
a matching module for interpreting the clustering.

5. The system of claim 4, wherein the information is at least one of a job skill and a course skill.

6. The system of claim 4, wherein the system is adaptive.

7. The system of claim 4, wherein the device for obtaining information is continuously obtaining more information.

8. The system of claim 7, wherein the information is stored in an electronic storage device.

9. A computer-readable medium having instructions thereon to perform the method of claim 1.

10. A computer-readable medium having instructions thereon to perform the method of claim 2.
